(19) United States
(12) Patent Application Publication
(10) Pub. No.: US 2011/0173645 A1
(43) Pub. Date: Jul. 14, 2011

(54) DISC LOADING AND EJECTING APPARATUS FOR SLOT-IN OPTICAL DISC DRIVES

(76) Inventors: Yuan-Hung CHANG, Hsinchu City (TW); Hung-Chang Chien, Hsinchu City (TW)

(21) Appl. No.: 12/776,090

(22) Filed: May 7, 2010

(30) Foreign Application Priority Data
Jan. 12, 2010 (CN) 201010001498.5

(51) Int. Cl. G11B 17/04

(52) U.S. Cl. 720/628

(57) ABSTRACT

A disc loading and ejecting apparatus for a slot-in optical disc drive to drive a compact disc into and out of the slot-in optical disc drive includes a driving portion and a guiding portion that are located at two opposite sides of the slot-in optical disc drive. The driving portion includes a transverse roller. The compact disc has one end abutted and held by the guiding portion and another end leaned on the roller. The roller can be rotated to load and eject the compact disc into or out of the slot-in optical disc drive. The roller is located at one end of the loading/ejecting path of the compact disc without extending traversely or occupying the transverse space of the path, thus the slot-in optical disc drive can be shrunk to a smaller size to meet slim and light design requirements.

### FIELD OF THE INVENTION

The present invention relates to a disc loading and ejecting apparatus for slot-in optical disc drives and particularly to a disc loading and ejecting apparatus equipped with an asymmetrical roller.

### BACKGROUND OF THE INVENTION

Slot-in optical disc drives can load and eject discs easily, thus have increasingly replaced the tray-type optical disc drives in recent years and are widely adopted on notebook computers, all-in-one computers, vehicle players or game machines. Refer to FIG. 1 for a conventional slot-in optical disc drive 1 which has an opening 2 to receive and position a compact disc 3 at a selected location. The optical disc drive 1 contains an optical pickup head to access data stored in the compact disc 3. The slot-in optical disc drive 1 has advantages of rapid loading and ejection of the compact disc 3, and maintaining holding stability of the compact disc 3 during the disc loading and ejection processes. Compared with the tray-type optical disc drive, the slot-in optical disc drive has a smaller disc loading and ejecting apparatus to guide and position the compact disc into or out of the optical disc drive, and requires less space without installing a tray mechanism, thus can shrink the volume of the optical disc drive. In addition, the disc loading and ejecting system is more appealing in use in terms of human/machine interaction.

Refer to FIG. 2 for the disc loading and ejecting apparatus of the conventional slot-in optical disc drive 1. It includes a transverse shaft 4 extended to couple with two opposite sides of the optical disc drive 1, and two elongate rollers 5 and 6 located axially and transversely of the shaft 4 in a symmetrical manner. The shaft 4 is driven by a motor 7 to rotate the elongate rollers 5 and 6 synchronously in the same direction. The compact disc 3 is loaded into the optical disc drive 1 through the opening 2, and the two elongate rollers 5 and 6 touch and press one side of the compact disc 3 to drag and move the compact disc 3 into the slot-in optical disc drive 1. The two elongate rollers 5 and 6 rotate synchronously to eject the compact disc 3 out of the optical disc drive 1.

As the shaft 4 and the two elongate rollers 5 and 6 are extended to the left and right sides and occupy a wide area, the disc loading and ejecting apparatus occupies a great transverse space of the slot-in optical disc drive 1. This is against the prevailing trend of designing a slim and light slot-in optical disc drive 1.

### SUMMARY OF THE INVENTION

Therefore, the primary object of the present invention is to provide a disc loading and ejecting apparatus for slot-in optical disc drives that can be made at a smaller volume to reduce the space occupied by the traditional disc loading and ejecting apparatus.

To achieve the foregoing object, the disc loading and ejecting apparatus according to the invention includes a driving portion which is located at one side of the slot-in optical disc drive and a guiding portion located at another side of the slot-in optical disc drive opposite to the driving portion. The driving portion includes a roller with a rotation axis in parallel with a positioning surface of a compact disc. When the compact disc is loaded into or ejected out of the optical disc drive, one end of the compact disc is abutted on the guiding portion and another end is leaned on the roller to be dragged into or out of the slot-in optical disc drive through rotation of the roller.

The roller of the invention is positioned in an asymmetrical manner, namely located at one end of the loading/ejecting path of the compact disc without extending transversely or occupying a lot of transverse space of the slot-in optical disc drive, thus the slot-in optical disc drive can be shrunk to a smaller size to meet the slim and light design requirement.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional slot-in optical disc drive;

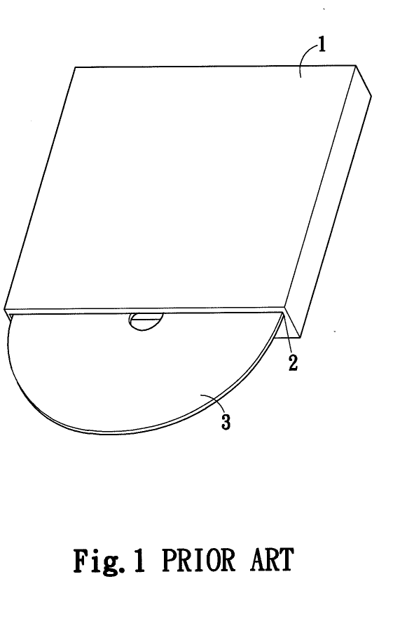

FIG. 2 is a schematic view of a disc loading and ejecting apparatus of a conventional slot-in optical disc drive;

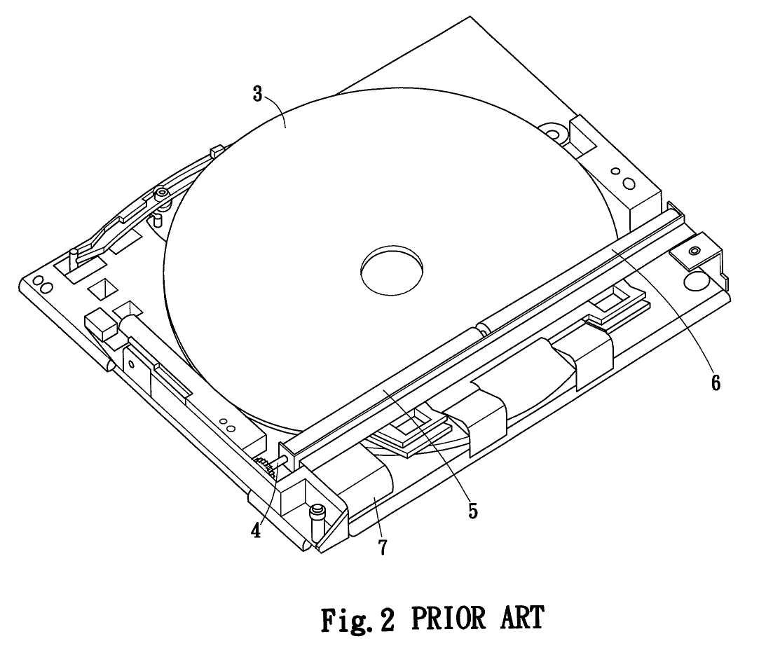

FIG. 3 is a perspective view of the disc loading and ejecting apparatus for slot-in optical disc drives of the invention;

FIG. 4 is a schematic view of loading a compact disc into the optical disc drive; and

FIG. 5 is a schematic view of a bevel roller.

### DETAILED DESCRIPTION OF THE PREFERRED EMBODIMENTS

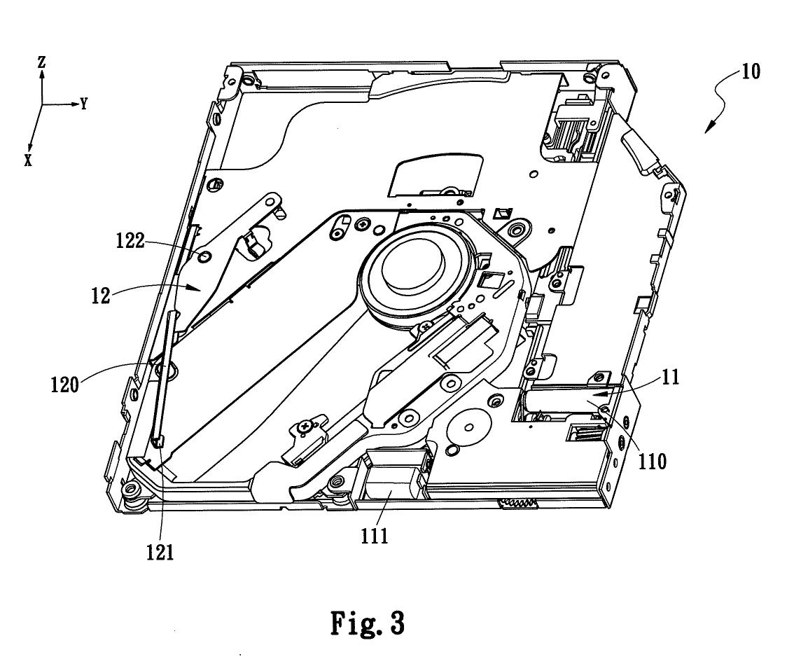

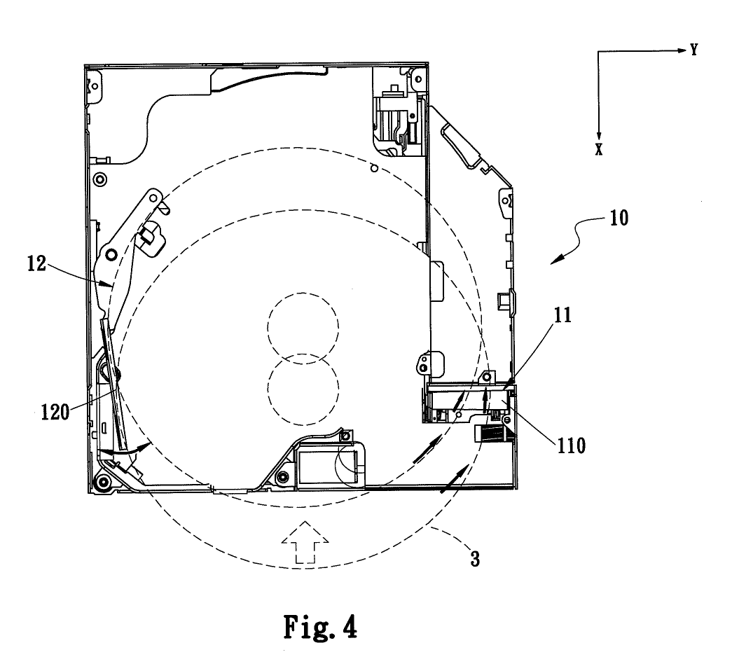

Please refer to FIGS. 3 and 4 for an embodiment of the disc loading and ejecting apparatus for slot-in optical disc drives of the invention. The disc loading and ejecting apparatus aims to drive a compact disc 3 into or out of a slot-in optical disc drive 10. The loading and ejecting apparatus comprises a driving portion 11 and a guiding portion 12 that are located at two opposite sides of the slot-in optical disc drive 10 as shown in FIG. 3. The driving portion 11 includes a roller 110 and a power source 111 such as a motor to rotate the roller 110 through a gear set including a plurality of engaging gears. The roller 110 is located in the optical disc drive 10 in an asymmetrical manner and has a rotation axis in parallel with a positioning surface of the compact disc 3 so that one end of the compact disc 3 leans on the roller 110 and is swivelable and movable by rotation of the roller 110. In this embodiment, the rotation axis is perpendicular to a lateral plate of the slot-in optical disc drive 10, but this is not the limitation. It is to be noted that “a positioning surface” mentioned above means a rotational plane after the compact disc 3 has been loaded and held in the slot-in optical disc drive 10, namely the XY plane as shown in FIG. 3. Moreover, refer to FIG. 3, the length of the roller 110 is about 2.5 cm and no longer than one half of the width of the optical disc drive, preferably smaller than the radius of a small compact disc (8 cm), namely smaller than 4 cm.

The compact disc 3 has a first end and a second end in contact with the guiding portion 12 and the driving portion 11, respectively. When the compact disc 3 is loaded into the slot-in optical disc drive 10 through an opening (not shown in FIGS. 3 and 4), the first end of the compact disc 3 is supported by the guiding portion 12 which provides friction resistance to form a relative static fulcrum. Referring to FIG. 4, the second end of the compact disc 3 is leaned on the roller 110 which provides an action force by rotation of the roller 110 to drive the compact disc 3 to be swung into the slot-in optical disc drive 10 around the first end which serves as the fulcrum. When ejecting the compact disc 3 from the optical disc drive 10 is desired, the roller 110 can be rotated in a direction opposite to the loading direction of the compact disc 3 so that the compact disc 3 can be swung out from the optical disc drive 10 reversely.

In the embodiment previously discussed, the guiding portion 12 includes a guiding member 120 such as an elongate groove with a retaining space 121 mating the thickness of the compact disc 3. The first end of the compact disc 3 can be abutted and held by the guiding member 120 and retained in the retaining space 121 so that no offset along Z axis is occurred and the loading and ejection of the compact disc 3 is smooth. The guiding member 120 also can maintain the two ends of the compact disc 3 in a mechanical equilibrium condition so that the compact disc 3 can be steadily loaded into the optical disc drive 10. On the other hand, the guiding portion 12 also can change its position during the disc loading and ejecting processes to provide friction along the contour of the compact disc 3, and also provide a buffer force and space during the movement of the compact disc 3. The guiding portion 12 can change its position by moving transversely or swinging. FIGS. 3 and 4 illustrates the guiding portion 12 rotates about a fixed fulcrum 122 to change the position of the guiding member 120 when loading the compact disc 3.

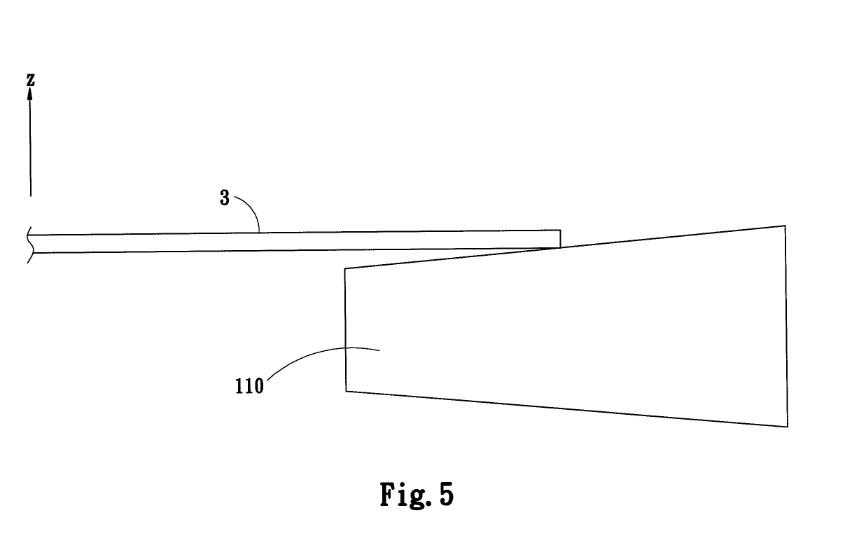

Referring to FIG. 5, the roller 110 may also be a bevel roller to minimize the second end of the compact disc 3 leaned on the roller 110 and to avoid damaging the surface of the compact disc 3 during the rolling of the roller 110. In another embodiment, the roller 110 is formed at a length about 1 to 10 times of its average diameter.

Furthermore, in order to load the compact discs with different sizes into the optical disk drive, such as compact discs with diameters of 8 cm or 12 cm, the length of the roller 110 is specially designed for this purpose so that different sizes of compact discs can be loaded into the desired position in the optical disc drive 10; or an appropriate location may be chosen for the roller 110 to guide the compact discs of varying sizes.

In the embodiments, the compact disc 3 is used for the slot-in optical disc drive 10. However, the disc is not limited to the compact disc (CD) and any disc such as digital versatile disc (DVD) or blue-ray disc (BD) may be used.

As a conclusion, the disc loading and ejecting apparatus of the invention allows the optical disc drive to be made smaller by shortening the length of the roller, and the width and height of the optical disc drive also can be reduced. It is especially desirable for the slot-in optical disc drive that requires a slim and light design. By incorporating with a single roller and mating action of the guiding portion, the contact area of the roller on the compact disc also decreases.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A disc loading and ejecting apparatus for a slot-in optical disc drive to drive a disc into and out of the slot-in optical disc drive, comprising:
a driving portion which is located at one side of the slot-in optical disc drive and includes a roller with a rotation axis in parallel with a positioning surface of the disc; and
a guiding portion located at another side of the slot-in optical disc drive opposite to the driving portion;
wherein one end of the disc is abutted on the guiding portion and another end is leaned on the roller while the disc is loaded into and ejected from the optical disc drive.

2. The disc loading and ejecting apparatus of claim 1, wherein the roller is driven by a power source.

3. The disc loading and ejecting apparatus of claim 2, wherein the power source is a motor.

4. The disc loading and ejecting apparatus of claim 1, wherein the roller is a bevel roller.

5. The disc loading and ejecting apparatus of claim 1, wherein the rotation axis of the roller is perpendicular to a lateral plate of the slot-in optical disc drive.

6. The disc loading and ejecting apparatus of claim 1, wherein the roller is formed at a length of one to ten times of the average diameter thereof.

7. The disc loading and ejecting apparatus of claim 1, wherein the guiding portion includes a guiding member which defines a retaining space corresponding to the thickness of the disc.

8. The disc loading and ejecting apparatus of claim 1, wherein the guiding portion includes a fixed fulcrum about which the guiding portion rotates.

9. The disc loading and ejecting apparatus of claim 1, wherein the guiding portion moves in a direction perpendicular to the loading direction of the disc.

10. The disc loading and ejecting apparatus of claim 1, wherein the roller is located in the optical disc drive in an asymmetrical manner and formed at a length smaller than 4 cm.
